(19) United States
(12) Patent Application Publication
(10) Pub. No.: US 2005/0133440 A1
(43) Pub. Date: Jun. 23, 2005

(54) Filter device and method of manufacturing the same

(75) Inventors: Katsuhiko Taniguchi, Toyota-shi (JP); Fumiyoshi Ariki, Kariya-shi (JP); Hiroyuki Shinkai, Kariya-shi (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignees: NIFCO INC., Yokohama-shi (JP); ADVICS CO., LTD., Kariya-shi (JP)

(21) Appl. No.: 11/013,097

(22) Filed: Dec. 16, 2004

(30) Foreign Application Priority Data
Dec. 19, 2003 (JP) 2003-423512

(51) Int. Cl. B01D 35/28

(52) U.S. Cl. 210/497.01; 210/435; 264/41

(57) ABSTRACT

A filter device includes a main body with a tubular shape having at least two outflow openings formed in a sidewall thereof with an interval in between around a tube axis for passing fluid such as oil; and a filter member with a tube shape embedded in the main body around the tube axis thereof to pass column portions formed between the outflow openings for closing the outflow openings. At least one of the column portions has a groove formed in an inner surface thereof to extend along the tube axis of the main body.

### BACKGROUND OF THE INVENTION AND RELATED ART STATEMENT

The present invention relates to a filter device disposed at an outlet of a pipe forming a fluid passage of fluid such as oil for filtering foreign materials in the fluid flowing out of the outlet, and a method of manufacturing the same.

Japanese Patent Publication (Kokoku) No. 06-11372 has discloses an oil strainer, and a filter device formed of a plastic tube is shown in FIG. 10. As shown in FIG. 10, such a filter device has a cylindrical shape with an open end and a closed end. Outflow openings 300 are formed in a sidewall of the filter device and closed with a filter member 301. The filter device is fitted into an outlet Pa of a pipe P for filtering foreign materials in fluid such as oil flowing out of the pipe P.

When the filter device is molded with injection molding, the filter member 301 formed in a cylindrical shape in advance is placed as an insert outside of a male mold 100 for forming an inner portion of the filter device. The filter member 301 thus inserted closes the outflow openings 300. Column portions 302 are molded with grooves 101 formed in the male mold 100 and grooves 201 formed in a female mold 200, and situated between the outflow openings 300. The filter member 301 passes through the column portions 302.

When the filter device is molded, a molten resin is injected into the molds at a high pressure, and the filter member 301 is pushed inwardly at the column portions 302 by the pressure. In this case, a part of the filter member 301 may be extended tightly, and another part of the filter member 301 may be loose between the outflow openings 300, thereby causing uneven tension in the filter member 301. In the injection molding, the molten resin is injected at a higher pressure at a location closer to a gate opening (X in FIG. 11). Accordingly, the filter member 301 tends to be pushed easily with the resin into the groove 101 of the male mold 100 located close to the gate opening. On the other hand, at a position away from the gate opening, the resin is injected with a lower pressure. Accordingly, the filter member 301 is pushed into the groove 101 with a lower pressure, thereby loosening the filter member 301. (The resin is not shown in FIG. 11.)

In view of the problems described above, an object of the present invention is to provide a filter device formed of plastic and having several outflow openings closed with a filter member, in which the filter member is inserted in a sidewall of the filter device with uniform tension.

Further objects and advantages of the invention will be apparent from the following description of the invention.

### SUMMARY OF INVENTION

In order to attain the objects described above, according to the present invention, a filter device includes the following three features (1) to (3): (1) a main body with a tubular shape having at least two outflow openings formed in a sidewall thereof with an interval in between around a tube axis for passing fluid such as oil; (2) a filter member with a tube shape inserted in the main body around the tube axis thereof and passing through column portions formed between the outflow openings for closing the outflow openings; and (3) at least one of the column portions having a groove formed in an inner surface thereof and extending along the tube axis of the main body.

With this structure, when the filter device is molded, a part of the male mold for forming the groove, i.e., a rib formed on the male mold, supports the filter member from inside. As a result, in the column portions formed between the outflow openings, it is possible to prevent the filter member from being pushed excessively into the main body with a pressure of a resin injected into the mold. It is also possible to prevent a case in which the filter member closes a part of the outflow openings 12 with a high tension, and closes other part of the outflow openings 12 with a low tension.

The resin is injected into the mold through the gate opening to form the main body. At least one of the column portions may have an outer side portion facing the gate opening of the mold and opposite to the groove formed in the inner surface of the column portion.

With this structure, it is possible to prevent the filter member from being pushed excessively into the main body at a position where the resin is injected with a highest pressure.

At least one of the column portions may have more than two grooves formed in the inner surface thereof.

With this structure, it is possible to prevent the filter member from being pushed excessively into the main body with more than two ribs formed on the male mold for forming the grooves.

According to the present invention, a tube shaped filter member is placed in a cavity between a male mold and a female mold. The male mold forms an inner portion of a tubular main body, and the female mold forms an outer portion of the tubular main body. The male mold has a groove in an inner surface of a portion thereof for forming a column portion of the main body. Then, a resin is injected into the cavity between the male mold the female mold to form the main body of a filter device.

In the method, when the main body is molded, the rib provided on the male mold supports the filter member from inside. Accordingly, it is possible to form the filter device while preventing the filter member from being excessively pushed into the main body by a pressure of the resin injected into the mold in the column portion between outflow openings.

According to the present invention, the filter member closes the outflow openings formed in the sidewall of the main body constituting the filter device with uniform tension.

### BRIEF DESCRIPTION OF THE DRAWINGS

FIG. 1 is a front view of a filter device according to the present invention;

FIG. 2 is a plan view of the filter device;

FIG. 3 is a bottom view of the filter device;

FIG. 4 is a cross sectional view taken along line 4-4 in FIG. 2;

FIG. 5 is a cross sectional view of the filter device and a pipe P in a separated state;

FIG. 6 is a cross sectional view of the filter device in use;

FIG. 7 is a sectional view of an essential part of a mold of the filter device;

FIG. 8 is a sectional view an essential part of the filter device molded from the essential part of the mold shown in FIG. 7;

FIG. 9 is a modified example of the filter device shown in FIGS. 1 to 8;

FIG. 10 is a perspective view of a conventional filter device; and

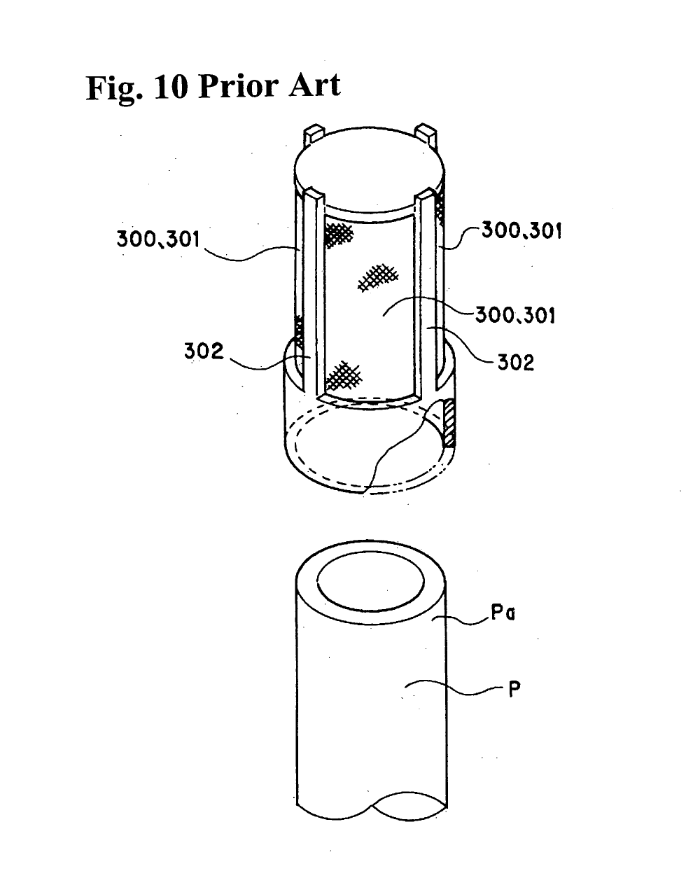

FIG. 11 is a cross sectional view of a mold of the conventional filter device.

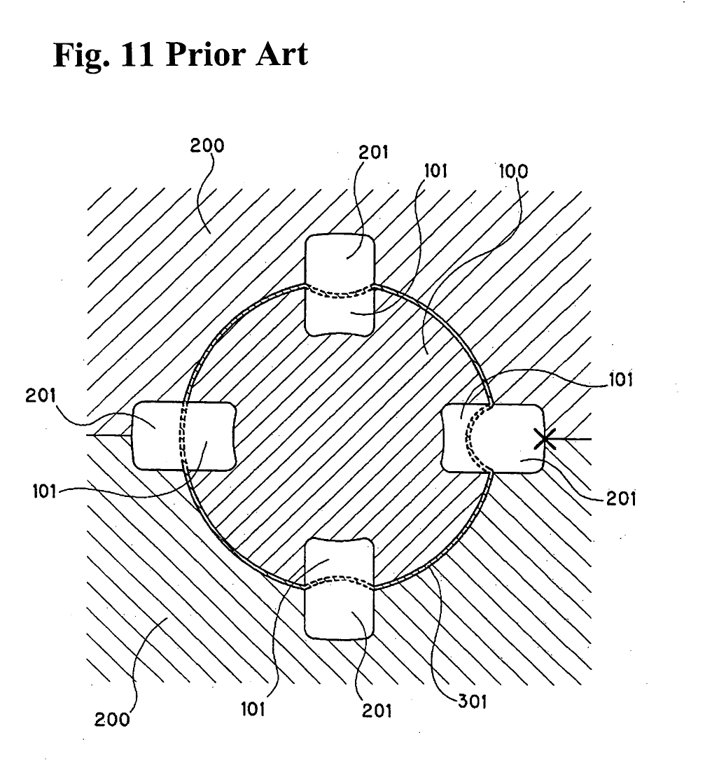

### DETAILED DESCRIPTION OF PREFERRED EMBODIMENTS

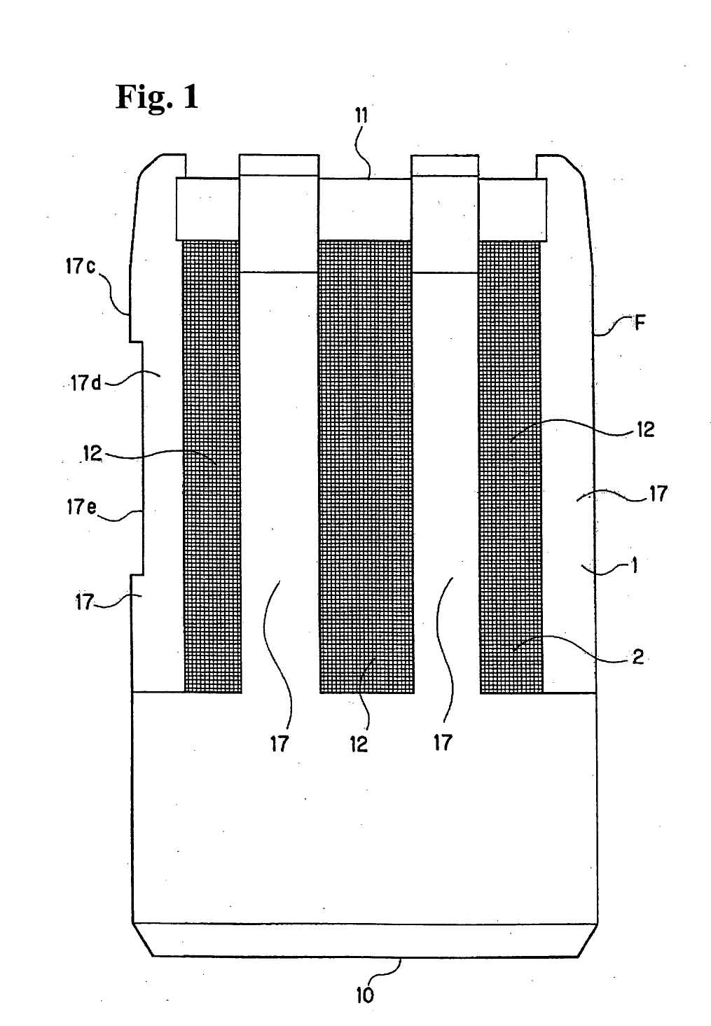

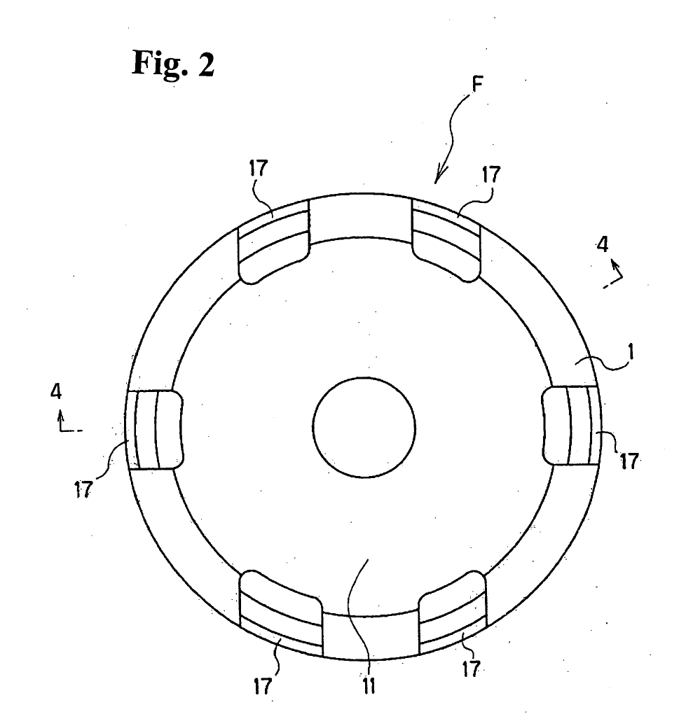

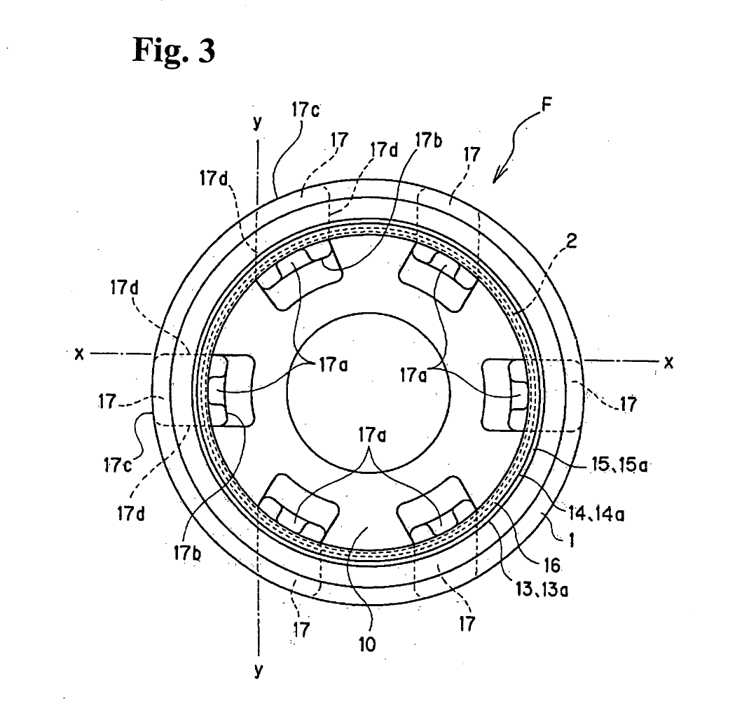

Hereunder, embodiments of the present invention will be described in detail with reference to FIGS. 1 to 9.

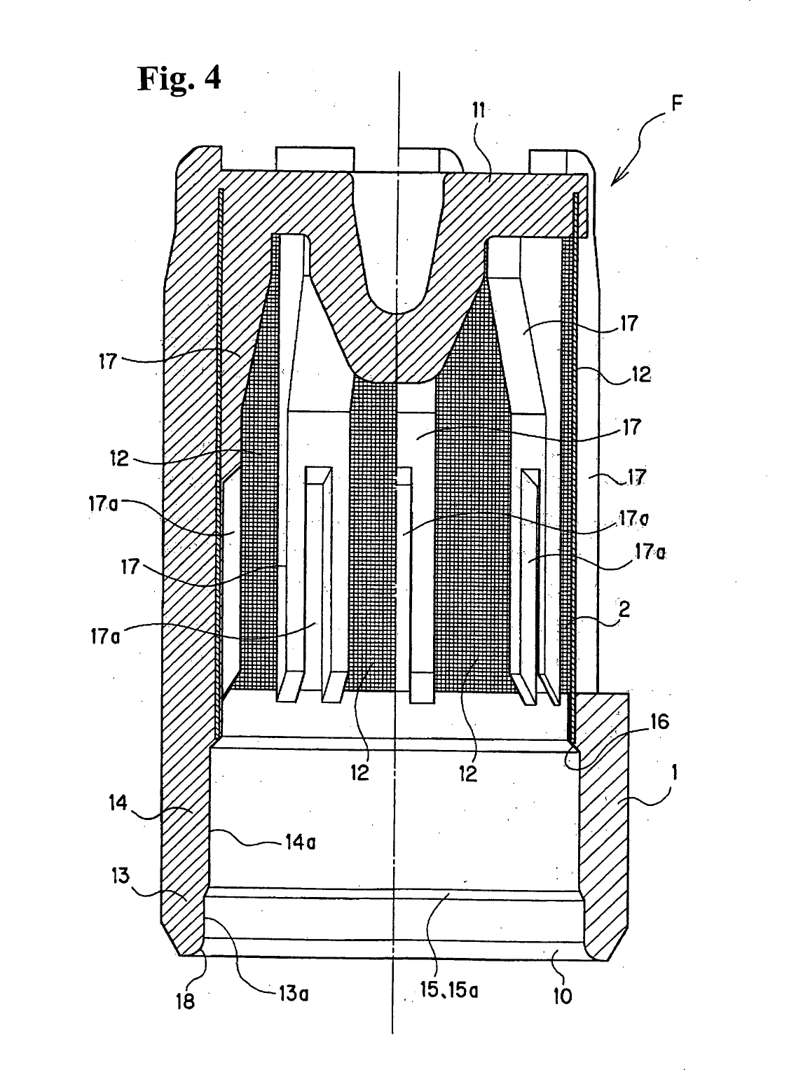

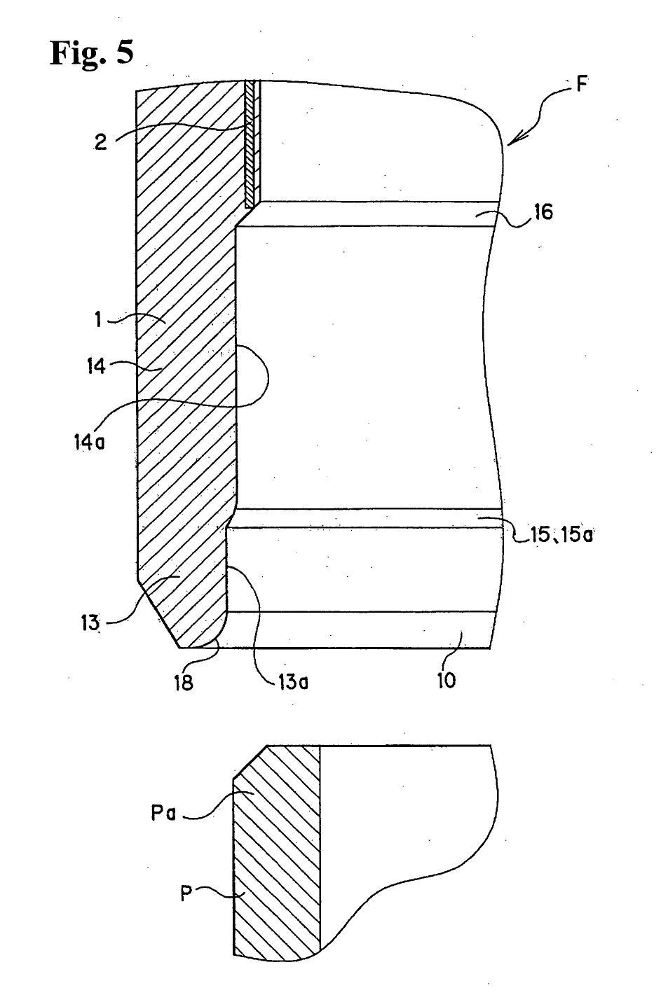

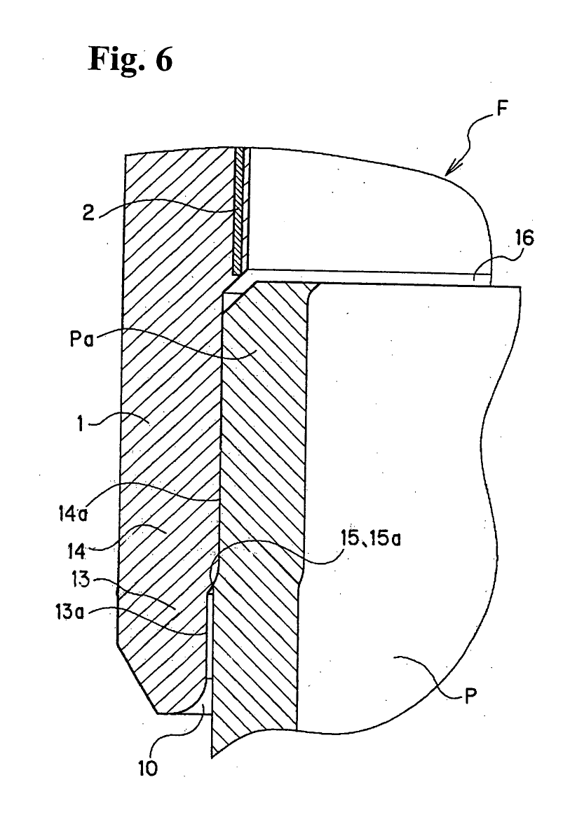

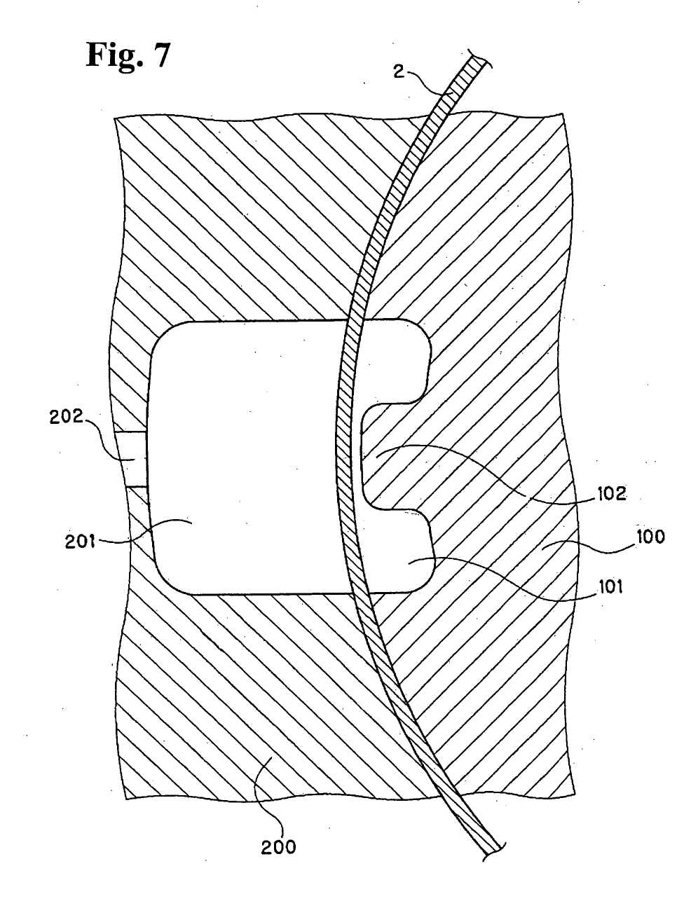

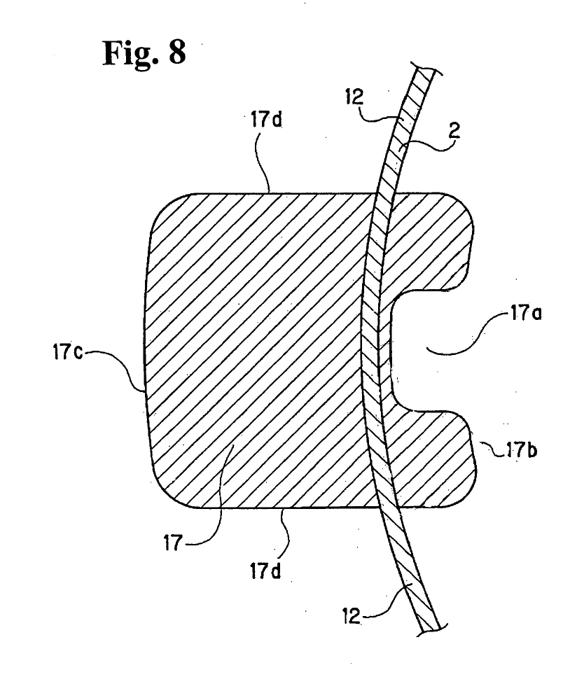

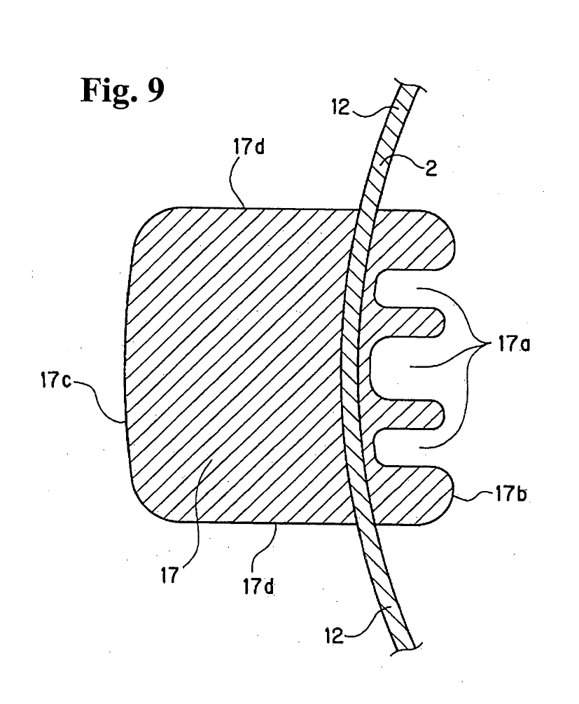

FIG. 1 and FIG. 4 show a filter device F according to an embodiment of the present invention. FIG. 5 shows the filter device F and a tube P to be inserted into the filter device F in a separated state. FIG. 6 shows an outlet Pa of the tube P inserted into the filter device F in an enlarged sectional view of an essential part of the filter device F. FIG. 7 is a partial sectional view of a mold for forming a column portion 17 located between outflow openings 12 of the filter device F. FIG. 8 shows a sectional view of an essential part of the filter device F molded with the part of the mold. FIG. 9 is a sectional view of an essential part of the filter device having three grooves 17a, 17a, and 17a formed in an inner surface 17b of the column portion 17.

In the embodiment, the filter device F is attached to the outlet Pa of the tube P forming a passage of fluid such as oil for filtering foreign materials in fluid flowing out of the outlet Pa.

The tube P includes a metal tube or pipe, and a rubber or plastic tube or pipe.

The filter device F has a main body 1 and a filter member 2. The main body 1 has an open one end 10 and a closed other end 11. In the embodiment shown in the drawings, the main body 1 is formed in a cylindrical shape. The pipe P is also formed in a cylindrical shape, and inserted into the main body 1 from the open end 10.

The main body 1 has outflow openings 12 in a side portion thereof closed with the filter member 2 for passing fluid such as oil. Accordingly, the filter member 2 captures foreign materials in fluid flowing out the outlet Pa of the pipe P, and fluid flows out of the outflow openings 12 after being filtered. In the embodiment, the outflow openings 12 are formed in an elongated rectangular shape extending along a tube axis of the main body 1. A plurality of the outflow openings 12 is formed in the side portion of the main body 1 with a distance in between around the tube axis of the main body 1.

The open end 10 of the filter device F is provided with an introduction part 13 having an inner diameter slightly larger than an outer diameter of the outlet Pa; a pressure receiving part 14 adjacent to the introduction part at an inner side and having an inner diameter slightly smaller than an outer diameter of the outlet Pa; and a guide part 15 formed of a plane inclined toward the pressure receiving part 14 and disposed between the introduction part 13 and the pressure receiving part 14.

In the embodiment, the introduction part 13 is formed between an end of the open end 10 of the main body 1 and the guide part 15. The introduction part 13 is formed of a first circumference surface 13a inside the main body 1 having a surface extending around the tube axis of the main body 1 and substantially in parallel to the tube axis. A curved surface 18 is formed at an inner end of the tube end 10 of the main body 1.

The pressure receiving part 14 extends from the guide part 15 toward an inner side of the main body 1, i.e., toward the closed end 11. The pressure receiving part 14 is formed of a second circumference surface 14a inside the main body 1 and having a surface extending around the tube axis and substantially in parallel to the tube axis. The pressure receiving part 14 extends toward the tube end 10 to a position away from opening edges of the outflow openings 12 by a specific distance. The pressure receiving part 14 is provided with a circumference step 16 facing the tube end 10 at an end portion thereof. The outlet Pa of the pipe P is inserted into the main body 1 close to the circumference step 16 from the tube end 10 of the main body 1.

The guide part 15 is formed of a circumference inclined surface 15a in the main body 1 inclined closer to the tube axis toward the pressure receiving part 14 and extending around the tube axis of the main body 1.

The introduction part 13 has an inner diameter slightly larger than an outer diameter of the outlet Pa of the pipe P. Accordingly, with the introduction part 13, it is possible to easily insert the outlet part Pa into the filter device F from the tube end 10 of the filter device F without shifting between an axis of the Pipe P and an axis of the filter device F, while minimizing an influence of the insertion on the filtering device 2. When the outlet Pa is inserted further inside, the outlet Pa is guided to the pressure receiving part 14 along the inclined surface of the guide part 15. Accordingly, the filter device F expands elastically, so that the outlet Pa is fitted into the pressure receiving part 14, thereby stably attaching the filter device F to the outlet Pa. The injection receiving part 14 formed adjacent to the introduction part 13 at the tube end 10 is fitted. The introduction part 13 prevents the injection receiving part 14 from deforming when the outlet Pa is inserted into the injection receiving part 14.

The filter member 2 is formed in a cylindrical shape around the tube axis of the main body 1, and passes through the column portions 17 formed between the outflow openings 12 of the main body 1 to close the outflow openings 12. In the embodiment, the main body 1 is made of plastic with general plastic injection molding while the filter member 2 is inserted. The filter member 2 is formed of mesh, and may be formed of unwoven cloth.

Specifically, a male mold 100 for forming an inner portion of the main body 1 is inserted into the filter member 2 with a cylindrical shape, thereby forming the main body with the filter member 2 as an insert.

The main body 1 has one or more than two grooves 17a extending along an axis direction of the main body 1 in an inner portion 17b of the column portion 17.

With this structure, a part of the male mold 100 for forming the groove 17a, i.e., a rib 102 provided on the male mold 100, can support the filter member 2 from inside when the main body is molded. As a result, in the column portion 17 formed between the outflow openings 12 of the main body 1, it is possible to prevent the filter member 2 from being excessively pushed into the main body 1 with a pressure of a resin injected into the mold upon molding. It is also possible to prevent a case in which the filter member 2 closes a part of the outflow openings 12 with a high tension, and closes other part of the outflow openings 12 with a low tension.

The groove 17a in the column portion 17 of the main body 1 is formed inside the groove 101 of the inner portion 17b of the column portion 17 with the rib 102 formed in the male mold 100 such as core pin for forming the inner portion of the main body 1, thereby forming the filter device F appropriately.

Specifically, a female mold 200 for forming an outer portion 17c of the main body 1 is provided with a groove 201 along a removal direction of the male mold 100. The male mold 100 for forming the inner portion 17b of the main body 1 is provided with the groove 101 along the removal direction of the male mold 100. The outer portion 17c of the column portion 17 is formed with the groove 201 of the female mold 200, and the inner portion 17b of the column portion 17 is formed with the groove of the male mold 100. The filter member 2 is placed outside the male mold 100, and passes through the column portion 17. When the male mold 100 is inserted into the female mold 200, a pitch of a wall thickness of the filter member 2 is formed between the female mold 200 and the male mold 100 at both sides of the grooves 101 and 201. Accordingly, it is possible to form the outflow openings 12 closed with the filter member 2 at both sides of the column portion 17. The rib 102 extending in the removal direction of the male mold 100 is provided inside the groove 101 formed in the male mold 100. In the embodiment, the rib 102 has a projecting end located on a surface same as an outside surface of the male mold 100 at sides of the groove 101. As shown in FIG. 9, when the column portion 17 is provided with the three grooves 17a, 17a, and 17a, two ribs 102 are provided inside the groove 101 of the male mold 100.

In this case, the ribs 102 provided in the male mold 100 support the filter member 2 from inside upon molding in the column portion 17 formed between the outflow openings 12. Accordingly, it is possible to prevent the filter member 2 from being excessively pushed into the main body 1 with a pressure of a resin injected into the mold, thereby forming the filter device F appropriately (refer to FIG. 7 and FIG. 8). In the embodiment, a concave part 17e is formed at a middle of the outer portion 17c of one of the column portions 17. A gate opening 202 of the female mold 200 is located at a portion for forming the concave part 17e. Accordingly, the filter member 2 receives a highest pressure of a resin in the column portion 17 provided with the concave part 17e. The rib 102 of the male mold 100 for forming the groove 17a of the column portion 17 prevents the filter member 2 passing through the column portion 17 from being pushed excessively.

In the embodiment, the main body 1 is provided with six outflow openings 12, and the column portions 17 are formed at six places. Two of the column portions 17 at opposed positions have sidewalls 17d extending in a thickness direction between inner walls and outer walls thereof and located on an imaginary first line X. The other column portions 17 between the two column portions 17 have sidewalls 17d extending in a thickness direction between inner walls and outside walls thereof and located on an imaginary second line Y substantially perpendicular to the first line X. Accordingly, the female mold 200 is formed of two parts divided along a parting line located at a middle of a width of the two column portions 17 with the sidewalls 17d located on the imaginary first line X. In the embodiment, an end portion of the filter member 2 at a side of the tube end 10 of the main body 1 is inserted in the main body 1 beyond opening edges of the outflow openings 12 at the side of the tube end 10. An end portion of the filter member 2 at a side the other tube end 11 of the main body 1 is inserted and supported in the main body 1 beyond opening edges of the outflow openings 12 at the side of the other tube end 11. According to the embodiments of the present invention, the filter device F described above is used for filtering fluid flowing into the main body 1 from the tube end 10, and may be used for filtering fluid flowing into the main body 1 through the outflow openings 12.

The disclosure of Japanese Patent Application No. 2003-423512, filed on Dec. 19, 2003, is incorporated in the application.

While the invention has been explained with reference to the specific embodiments of the invention, the explanation is illustrative and the invention is limited only by the appended claims.

1. A filter device comprising:
a main body having a cylindrical shape with a side portion, said main body including at least two openings in the side portion around an axis thereof for passing fluid, and column portions situated between the openings, at least one of said column portions having at least one groove in an inner surface thereof extending along the axis, and
a filter member having a cylindrical shape around the axis of the main body, said filter member passing through the column portions for closing the openings.

2. A filter device according to claim 1, wherein said main body includes a closed end portion, and a cylindrical portion at a side opposite to the closed end portion to be connected to a pipe, said column portions extending between the closed end portion and the cylindrical portion.

3. A filter device according to claim 2, wherein said filter member extends from the closed end portion to the cylindrical portion.

4. A filter device according to claim 3, wherein said groove extends from the cylindrical portion to a portion between the cylindrical portion and the closed end portion.

5. A filter device according to claim 1, wherein each of said column portions has an outer portion and an inner portion, said outer portion having two lateral sides extending parallel to each other, lateral sides of at least one of the column portions extending perpendicular to lateral sides of at least another of the column portions.

6. A filter device according to claim 5, wherein said inner portions of the column portions are all oriented toward the axis.

7. A filter device according to claim 1, wherein at least one of said column portions includes at least two grooves at the inner portion thereof.

8. A method of manufacturing the filter device according to claim 1, comprising preparing a male mold having at least one rib for forming the groove, assembling the male mold with a female mold to form a mold cavity while placing the filter member in the mold cavity, and injecting a resin into the mold cavity through a gate opening to mold the filter device.

9. A method according to claim 8, wherein said lid is located at a position facing the gate opening.
